(19) United States
(12) Patent Application Publication
(10) Pub. No.: US 2008/0069626 A1
(43) Pub. Date: Mar. 20, 2008

(54) Wrist writing apparatus and method thereof

(76) Inventor: John E. Cribbs, Plymouth, MA (US)

Correspondence Address: IANDIORIO & TESKA, 260 BEAR HILL ROAD, WALTHAM, MA, 02451-1018, US

(21) Appl. No.: 11/521,013

(22) Filed: Sep. 14, 2006

(51) Int. Cl. B43K 29/00

(52) U.S. Cl. 401/195

(57) ABSTRACT

A wrist writing apparatus including an ergonomically shaped chassis for attaching to a wrist including two parallel plates each having a pair of lobes on opposite ends of a curved surface. A writing surface is connected between the two parallel plates. An attachment device secures the chassis to the wrist. Rotating shafts are each associated with opposite lobes. A core of a rolled writing substrate is disposed about one rotating shaft. A take-up core is disposed about the other rotating shaft. The writing substrate is disposed across the writing surface and is attached to the take-up core such that rotating the first and second shafts provides a continuous writing area on the writing substrate disposed across the writing surface.

### FIELD OF THE INVENTION

This invention relates to an improved wrist writing apparatus and method.

### BACKGROUND OF THE INVENTION

Carpenters, woodworkers, craftsmen, and the like, often need to take and record measurements. Conventional methods for taking and recording measurements include taking a measurement, e.g., with a retractable tape measure, putting the tape measure away, picking up a writing pad and a writing device, and recording the measurement. The pad and the writing device are then put aside, the tape measure again picked up, and the next measurement is taken and recorded in the same manner. The process is repeated until enough measurements are made to cut the desired piece of material(s). Often, the writing pad and/or writing device are not located near the location of the measurement, which requires walking back and forth between the location of the pad and the location of the measurement.

As a result, conventional methods for taking and recording measurements are time consuming and labor intensive. Moreover, the tape measure, writing device, and/or writing pad are often misplaced, which further exasperates the problems associated with conventional note taking and measurement recording methods.

Conventional methods for note taking, shopping notes, notes used by doctors and nurses, notes for driving directions, or any type of note taking activity, also require a separate writing device and writing pad which must be picked up and the notes taken thereon. The writing pad and writing device are often misplaced and are inconvenient to carry. Moreover, notes cannot be easily taken while shopping, walking, driving, riding a motorcycle, or similar type activities.

### SUMMARY OF THE INVENTION

It is therefore an object of this invention to provide a wrist writing apparatus and method thereof.

It is a further object of this invention to provide such as wrist writing apparatus and method which is simple and easy to use.

It is a further object of this invention to provide such a wrist writing apparatus and method which decreases the time needed to measure and record multiple measurements.

It is a further object of this invention to provide such a wrist writing apparatus and method which eliminates misplacement of a writing pad.

It is a further object of this invention to provide such a wrist writing apparatus and method which eliminates misplacement of a writing device.

It is a further object of this invention to provide such a wrist writing apparatus and method which provides a convenient and easy way to take notes while performing an activity.

It is a further object of this invention to provide such a wrist writing apparatus and method which provides a continuous writing area and a writing device on the wrist of a user for convenient and easy note taking.

The subject invention results from the realization that an innovative wrist-writing apparatus and method that provides for convenient note-taking and, in one preferred embodiment, for fast and easy taking and recording of measurements, is effected with an ergonomically shaped chassis for attaching to a wrist. The chassis typically includes two parallel plates each having a pair of lobes on opposite ends of a curved surface. A writing surface is connected between the two parallel plates. An attachment device secures the chassis to the wrist. Rotating shafts are associated with opposite lobes. A core of a rolled writing substrate is disposed about one rotating shaft. A take-up core is disposed about the other rotating shaft. The writing substrate is disposed across the writing surface and is attached to the take-up core such that rotating the first and second shafts provides a continuous writing area on the writing substrate disposed across the writing surface for convenient note taking. In one embodiment, a measuring device may be attached to the attachment device to provide for fast and easy measurement taking and recording on the continuous writing area.

This invention features a wrist writing apparatus including an ergonomically shaped chassis for attaching to a wrist. The chassis includes two parallel plates each having a pair of lobes on opposite ends of a curved surface. A writing surface is connected between the two parallel plates. An attachment device secures the chassis to the wrist. Rotating shafts are each associated with opposite lobes. A core of a rolled writing substrate is disposed about one rotating shaft. A take-up core is disposed about the other rotating shaft. The rolled writing substrate is disposed across the writing surface and is attached to the take-up core such that rotating the first and second shafts provides a continuous writing area on the writing substrate disposed across the writing surface.

In a preferred embodiment, a securing device may secure a writing device. The securing device may include a hollow area in one or both of the shafts. The securing device may include a clip attached to the chassis. The attachment device may include a flexible band with loop mechanisms on one surface and hook mechanisms on another surface. The attachment device may include a band with a hook and eye device. The band may be made of a material chosen from the group consisting of a cloth material, a leather material, a plastic material, and neoprene. The measuring device may be attached to the attachment device. One or both of the first and second shafts may include a shelf sized to fit at least one orifice. One or both of the rotating shafts may be solid. The hollow area may include a tapered portion for further securing the writing device. One of the rotating shafts may include a plurality of splines for securing the core of rolled writing substrate. The other rotating shaft may include a plurality of splines for securing the take-up core. The core of a rolled writing substrate may include rolled paper. One end of one or both of the shafts may include a clip device for securing the shaft to the chassis. The core of a rolled writing substrate may include preprinted data. A patch of pressure sensitive hook mechanisms may be attached to the chassis for engaging the loop mechanisms on the flexible band to attach the attachment device to the chassis. A patch of pressure sensitive hook mechanisms may be attached to the measuring device for engaging loop mechanisms on one surface of a flexible band of the attachment device for attaching the measuring device to the flexible band.

This invention also features a wrist measuring and recording apparatus including an ergonomically shaped chassis for attaching to a wrist. The chassis includes two parallel plates each having a pair of lobes on opposite ends of a curved surface. A writing surface is connected between the two parallel plates. Rotating shafts are each associated with opposite lobes. An attachment device secures the chassis to the wrist. A measuring device for performing measurements is attached to the attachment device. A core of a rolled writing substrate is disposed about one rotating shaft. A take-up core is disposed about the other rotating shaft. The writing substrate is disposed across the writing surface and is attached to the take-up core such that rotating the first and second shafts provides a continuous writing area on the writing substrate disposed across the writing surface for recording one or more measurements on the writing area.

This invention also features a wrist writing apparatus including an ergonomically shaped chassis for attaching to a wrist. The chassis includes two parallel plates each having a pair of lobes, each lobe having an orifice therein. A writing surface is connected between the two parallel members. A first rotating shaft is disposed through an orifice in one of the lobes and through an opposing orifice in another lobe. A second rotating shaft is disposed through an orifice in one of the lobes and through an opposing orifice in another lobe. One of the first and second shafts is hollow for receiving a writing device. A core of rolled writing substrate is disposed about the first rotating shaft. A take-up core is disposed about the second rotating shaft. The writing substrate is disposed across the writing surface and is attached to the take-up core such that rotating the first and second shafts provides a continuous writing area on the writing substrate disposed across the writing surface.

This invention also features a method for measuring and recording measurements to a wrist writing device including a) performing a measurement using a measuring device attached to the wrist writing device, b) removing a writing device secured to the wrist writing device, c) recording the measurement on a continuous writing area provided by rolled writing substrate disposed across a writing surface of the wrist writing device; and d) repeating steps a) through c) until a predetermined number of measurements are taken and recorded on the continuous writing area.

In a preferred embodiment, the writing device may be secured in a hollow area in a rotating shaft of the writing device. The writing device may be secured to a chassis of the wrist writing device.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional bottom view of one embodiment of the wrist writing apparatus of this invention;

FIG. 2 is a three-dimensional top view of the wrist writing apparatus shown in FIG. 1;

FIG. 3 is three-dimensional view showing one embodiment of the wrist writing apparatus of this invention attached to a wrist of a user and the writing device being inserted into a hollow rotating shafts;

FIG. 4 is a three-dimensional front view showing the writing device secured within a hollow rotating shaft shown in FIGS. 1-3;

FIG. 5 is a three-dimensional view showing a user writing on the writing area of continuous writing surface of the wrist writer apparatus show in FIGS. 3 and 4;

FIG. 6 is another three-dimensional bottom view of the wrist writing apparatus of this invention showing in further detail an example of the core of a rolled writing substrate of this invention;

FIG. 7 is a three-dimensional side view showing an example of an attachment device used to secure the chassis of the wrist writing apparatus of this invention to the wrist of a user;

FIG. 8 is a three-dimensional schematic side view showing the wrist writing apparatus shown in FIG. 7 secured to the wrist of a user;

FIG. 9 is a schematic side view showing an example of protruding splines on one rotating shaft of this invention used to secure the core of a rolled writing substrate to the shaft;

FIG. 10 is a schematic three-dimensional side view showing in further detail some of the components of the rotating shafts in accordance with this invention;

FIG. 11 is a schematic three-dimensional side view showing an example of a clip mechanism used to secure the rotating shafts to the chassis in accordance with this invention;

FIG. 12 is a schematic side view showing another example of a clip used to secure the rotating shafts to the chassis of this invention;

FIG. 13 is a schematic side view showing an example of a tapered portion in a hollow area of one of the rotating shafts of this invention used to secure the writing device in the hollow shaft;

FIG. 14 is a schematic side view showing an example of an attachment device used to secure the writing device to the chassis of the wrist writing apparatus of this invention;

FIG. 15 is a three-dimensional view showing an example of a measuring device secured to the attachment device of this invention;

FIG. 16 is a three-dimensional view showing an example of a patch of hook mechanisms on the measuring device for attaching to the measuring device to the flexible band shown in FIG. 15.

FIG. 17 is a three-dimensional view showing an example of a user performing and recording a measurement in accordance with one embodiment of this invention; and

FIG. 18 is a three-dimensional view showing in further detail the user recording the measurement taken in FIG. 17.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

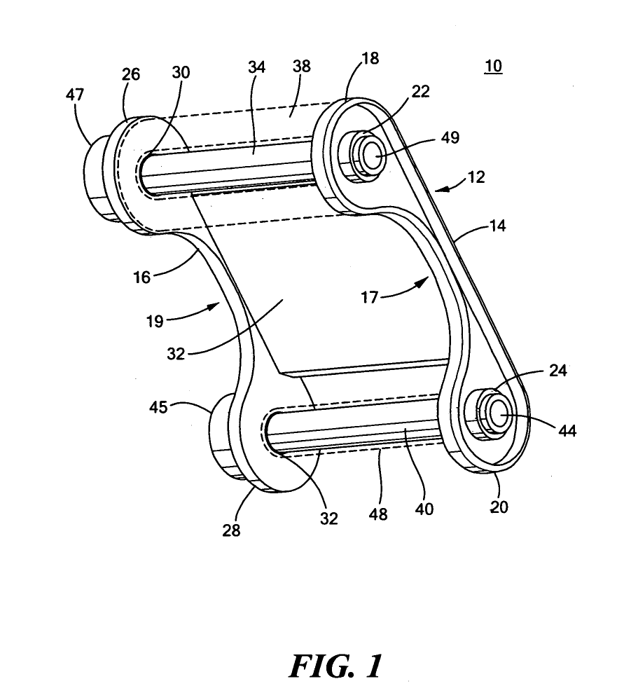

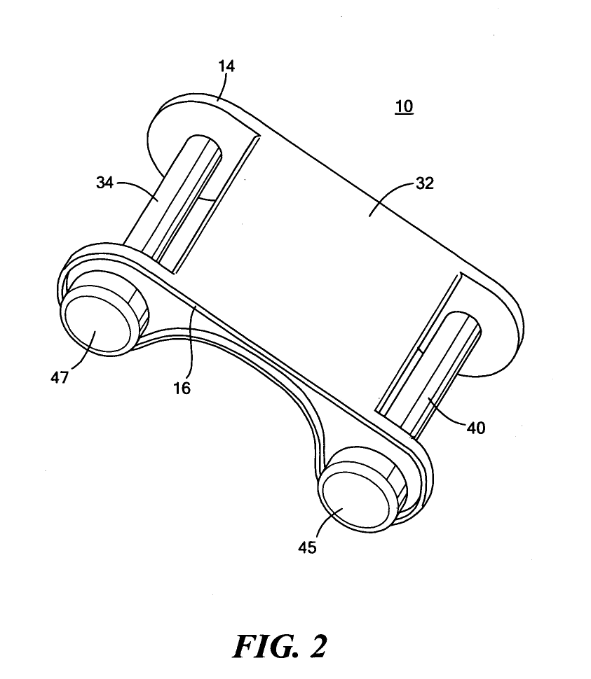

Wrist writing apparatus 10, FIG. 1 of this invention, includes ergonomically shaped chassis 12 for attaching to the wrist of a user. Chassis 12 includes parallel plates 14 and 16 and is typically made of plastic or a similar type materials. Plate 14 includes curved surface 17 and lobes 18 and 20 with orifices 22 and 24, respectively. Plate 16 similarly includes curved surface 19 and lobes 26 and 28 with orifices 30 and 32, respectively. Curved surfaces 17 and 19 are shaped to ergonomically fit about the wrist of a user. Writing surface 32, FIG. 2, is connected between parallel plates 14 and 16. In one design, rotating shaft 34 is disposed through orifice 30, FIG. 1, in lobe 26 and through opposing orifice 22 in lobe 18. Core of a rolled writing substrate 38, e.g., rolled paper, is disposed about rotating shaft 34 (discussed below). Similarly, rotating shaft 40 is disposed through orifice 32 in lobe 28 and through opposing orifice 24 in lobe 20. One or both of rotating shafts 34 and 40 may be hollow for receiving a writing device. In this example, rotating shaft 40 is hollow and includes area 44 for receiving and securing a writing device. Similarly, rotating shaft 34 may be hollow and include area 49 for receiving a writing instrument. In other designs, rotating shaft 34 may be solid while rotating shaft 40 is hollow or rotating shaft 40 may be solid and rotating shaft 34 is hollow, or any combination thereof. In yet another design, both rotating shafts 34 and 40 are solid and a clip device is used to secure the writing instrument to chassis 12 (discussed below). Although as described above rotating shafts 34 and 40 are disposed through the orifices in the lobes of chassis 12 to secure the rotating shafts 34 and 40 to chassis 12, this is not a necessary limitation of this invention, as rotating shaft 34 and/or rotating shaft 40 may be attached to chassis 12 using pins, detents, journals, or any technique known to those skilled in the art.

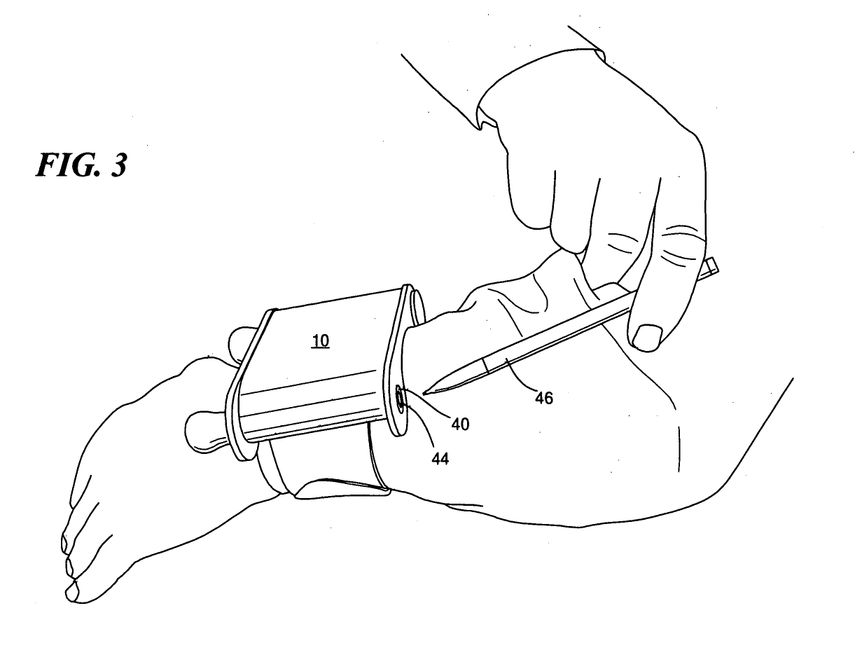

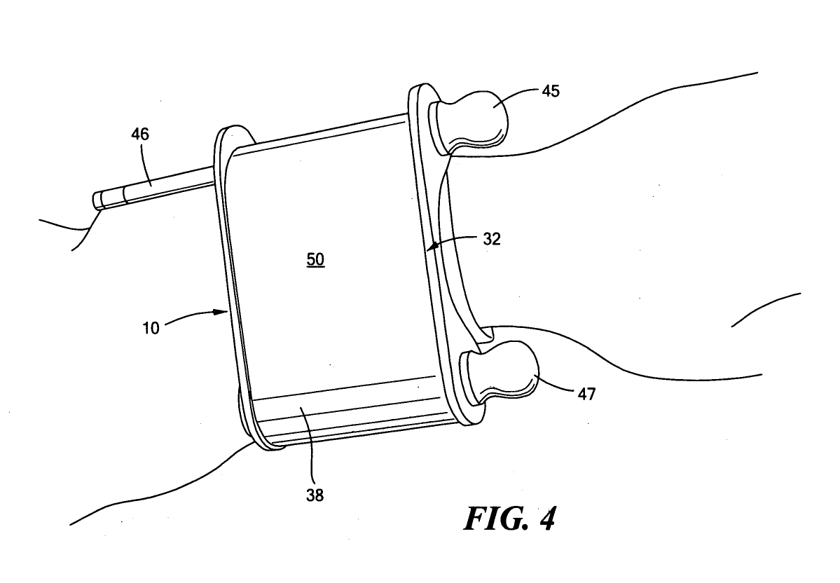

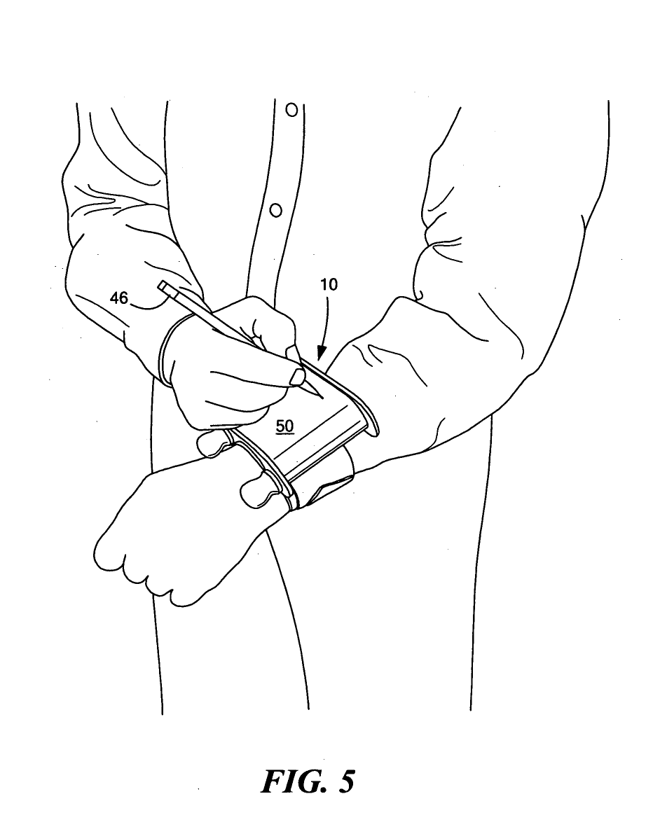

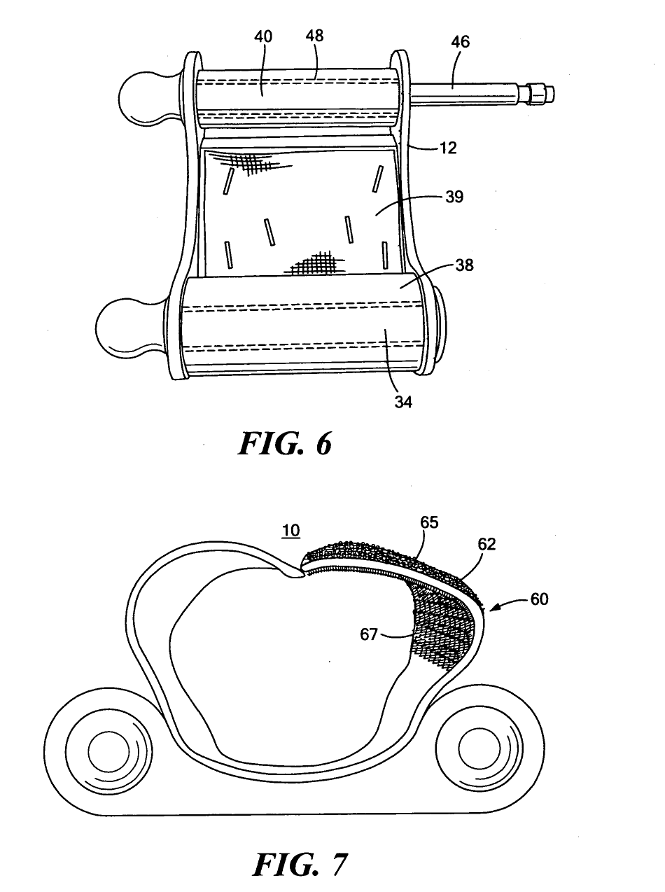

FIG. 3 shows an example of writing device 46 being inserted in area 44 of hollow rotating shaft 40. FIG. 4 shows writing device 46 secured in rotating shaft 40. Take-up core 48, FIG. 1, is disposed about rotating shaft 40. Knob 45 is attached to rotating shaft 40 and knob 47 is attached to rotating shaft 34. The writing substrate of core of a rolled writing substrate 38 is attached from rotating shaft 34 across writing surface 32 to take-up core 48 about rotating shaft 40 such that rotating shafts 34 and 40, e.g., with knob 45, provides a continuous writing area 50, FIG. 4 on the writing substrate disposed across writing surface 32. FIG. 5 shows an example of a user note taking on continuous writing area 50 with writing device 46. FIG. 6 shows in further detail core of a rolled writing substrate 38, e.g., rolled paper, disposed about rotating shaft 34 (shown in phantom) and the rolled paper being taken up by take-up core 48 about rotating shaft 40 (shown in phantom).

The result is wrist writing apparatus 10 of this invention provides a convenient and easy way for note taking on the continuous writing area. The hollow area in one or both of the rotating shafts or a clip mechanism on the shaft provides a convenient area for storing the writing device. The continuous writing area on the writing surface is located on the ergonomically shaped chassis attached to the wrist of the user to provide for convenient note taking while performing various activities, such as shopping, walking, motorcycle riding, or any type of note taking activity. Wrist writing apparatus 10 can also be used by doctors, nurses, tradesmen, and the like, for convenient note taking. Moreover, when the core of a rolled writing substrate is completely used, it can be removed and stored for recordkeeping. Additionally, preprinted data on the core of a rolled writing substrate 38, e.g., measurements for wood working, directions, and the like can be provided so that the user can take notes directly on the preprinted core of rolled writing substrate.

Wrist writing apparatus 10, FIG. 7, includes attachment device 60 for attaching chassis 12 to the wrist of a user. Attachment device 60 preferably includes flexible band 62 with a loop mechanisms on one surface, e.g., surface 65, and a hook mechanisms on the other surface, e.g., surface 67, such as VELCRO® or similar type materials. Preferably, attachment device 60 is attached to chassis 12 by attaching patch 39, FIG. 6, of pressure sensitive hook mechanisms to chassis 12 with glue, staples, or similar type devices. The hook mechanisms on patch 39 attach to the loop mechanisms on surface 65, FIG. 7 of the flexible band 62 to secure flexible band 62 to chassis 12. Flexible band 62 may also be attached to chassis 12 by staples, glue, tacks or equivalents thereof. In other designs, attachment device 60 may be made of cloth, leather, plastic, neoprene, or any material known to those skilled in the art, and include a hook and eye device (not shown), similar to a conventional belt. FIG. 8, where like parts have been given like numbers, shows an example of wrist writing apparatus 10 of this invention secured to the wrist of a user with attachment device 60.

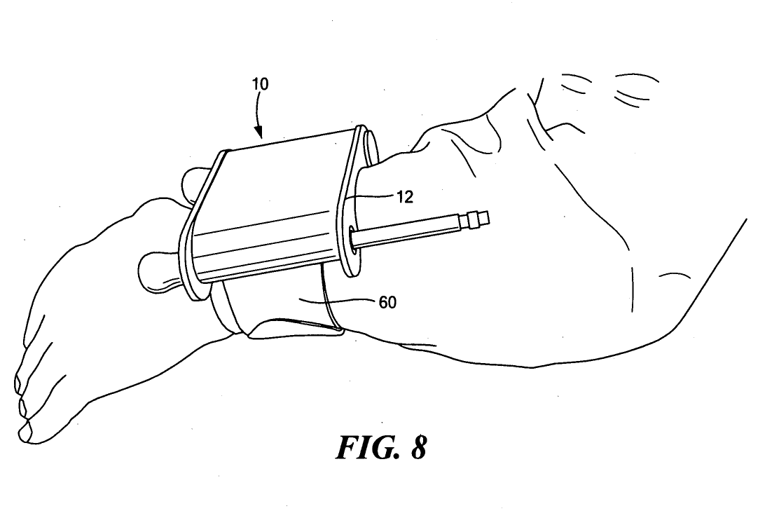

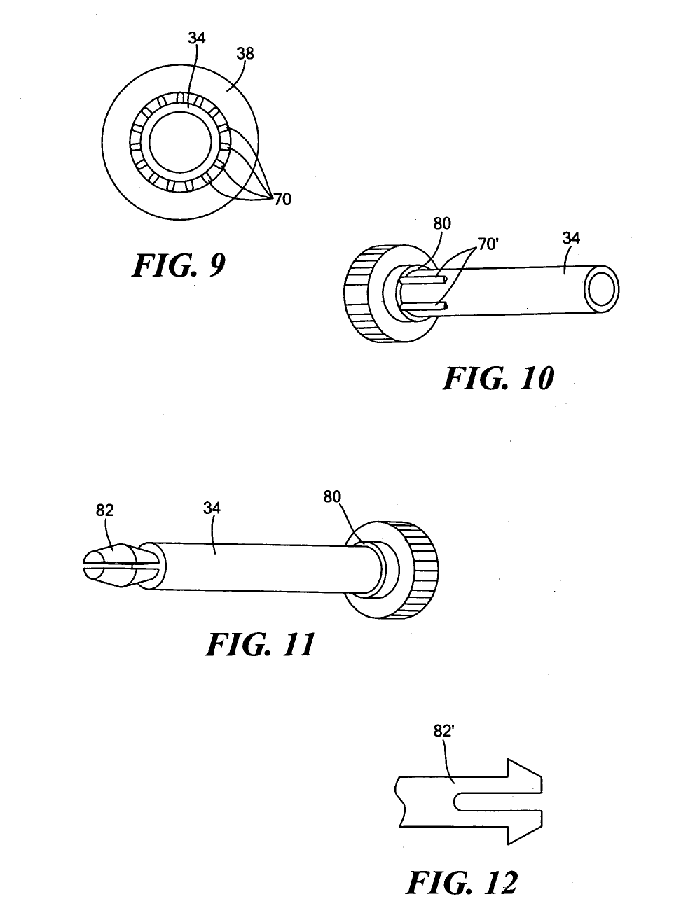

In one design, core of a rolled writing substrate 38, FIG. 1, is attached to rotating shaft 34 by a plurality of splines 70, FIG. 9, which protrude from rotating shaft 34 to attachably secure core of a rolled writing substrate 38 to shaft 34. In a similar manner, plurality of splines 70 may be used to secure take-up core 48, FIG. 1, to rotating shaft 40.

In one embodiment of this invention, rotating shaft 34 may be secured within orifice 30 by a shelf protruding from the shaft, e.g., shelf 80, FIG. 10, where like parts have been given like numbers, which fits into orifice 30, FIG. 1. Splines 70′, FIG. 10, secure the core of a rolled writing substrate to rotating shaft 34. Similarly, rotating shaft 48, FIG. 1 may include shelf 82, FIG. 10 that fits into orifice 32 and splines 70′ for securing the take-up core to rotating shaft 48.

Rotating shaft 34, FIG. 1, may include clip device 82, FIG. 11, for securing the other end of rotating shaft 34 into orifice 22, FIG. 1. Similarly, rotating shaft 40 may include clip device 82 for securing the other end of rotating shaft 40 into orifice 24. Another example of a clip device that may be used to secure rotating shaft 34 and/or rotating shaft 40 into orifices 22 and 24, respectively, is clip device 82′, FIG. 12.

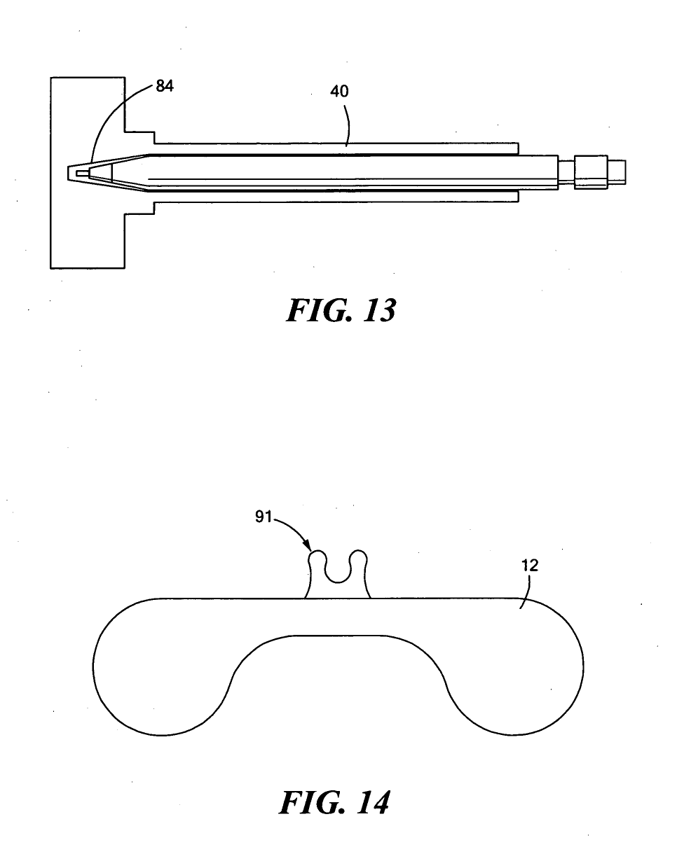

In one design, rotating shaft 40, FIG. 13, may be hollow and includes tapered portion 84 for securing the writing device in the shaft. Similarly, rotating shaft 34, FIG. 1 may be hollow and may include tapered portion 84, FIG. 13 for securing the writing device in rotating shaft 34.

Although as described above, one or both of rotating shafts 34 and 40 may be hollow for securing writing device 46, this is not a necessary limitation of this invention, as one or both of rotating shafts 34 and 40 may be solid. In this design, clip 91, FIG. 14, e.g., a clevis type clip, is attached to chassis 12 and secures the writing device to the chassis.

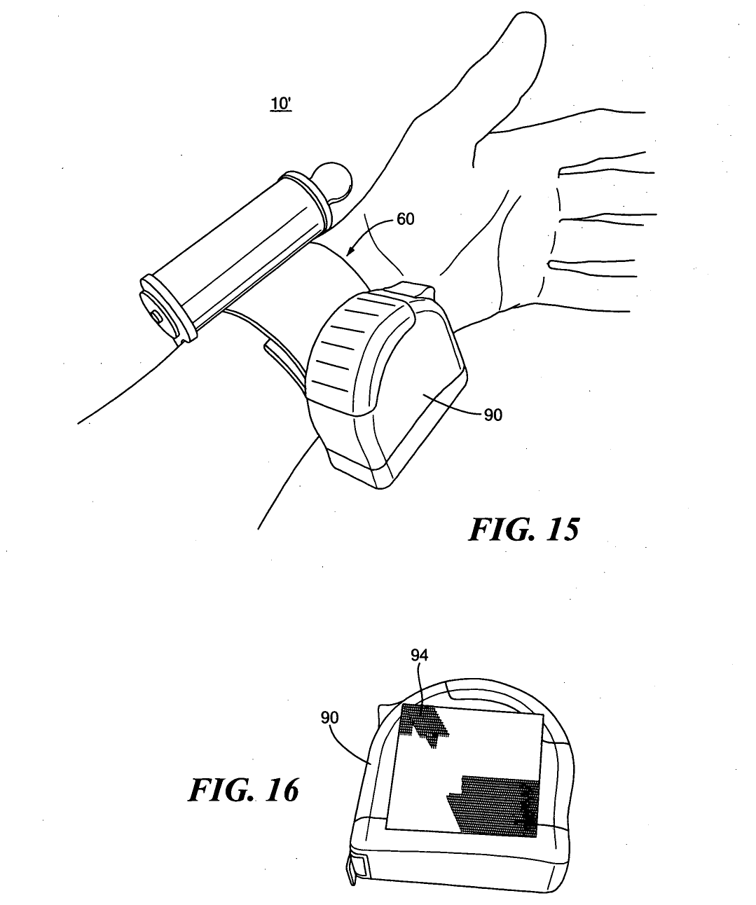

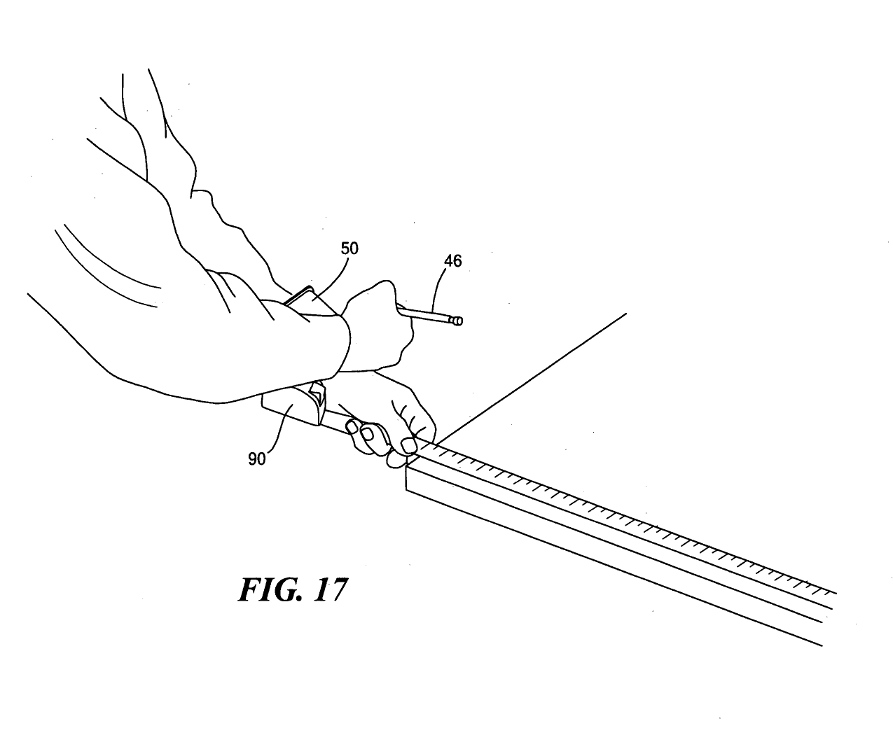

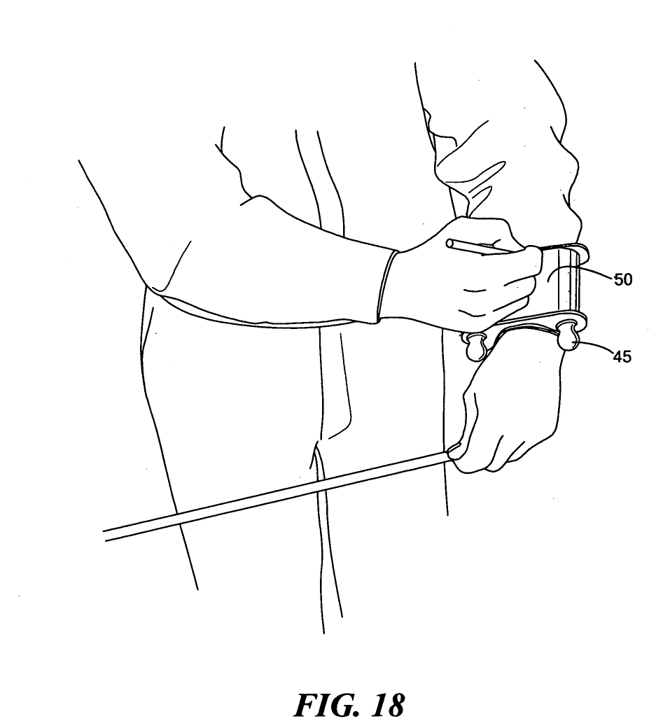

In one preferred embodiment, wrist writing apparatus 10′, FIG. 15, where like parts have been given like numbers, includes measuring device 90, e.g., a retractable tape measure, attached to wrist attachment device 60. In one example, a patch 94, FIG. 16, of pressure sensitive hook mechanisms is attached to measuring device 90 with glue or equivalents thereof. The hook mechanism on patch 90 engage the loop mechanisms on surface 65, FIG. 7 of flexible band 62 to attach measuring device 90 to flexible band 62. In other examples, a clip on the back of measuring device 90 (not shown) may be used to attach measuring device 90 to flexible band 62. Measuring device 90 provides for efficient and easy use for carpenters, woodworkers, tradesmen, and the like, to conveniently take measurements. FIG. 17 shows a user employing measurement device 90 to take a measurement and record the measurement on continuous writing area 50 using writing device 46. FIG. 18 shows the user recording the measurement on a continuous writing area 50 and holding tape measure device in place with his thumb.

Thus, wrist writing apparatus 10′ allows the carpenters, woodworkers, tradesmen, and the like, to easily take and record multiple measurements. In operation, the user simply takes a desired measurement, holds the measurement device in place with his thumb (as shown in FIG. 18), removes the writing device from the hollow core of the rotating shaft or the clip on the chassis, records the measurement on the continuous writing area 50, puts the writing device back into the hollow core or clip, and then takes the next measurement. When continuous writing area 50, FIG. 18 is filled with data, knob 45 is rotated so that the core of rolled writing substrate provides additional continuous writing area 50. There is no need to locate and pick up a writing pad or walk back and forth from the location of the measurement. The result is wrist writing apparatus 10′ eliminates multiple steps associated with conventional methods for taking and recording measurements as discussed in the Background section above which saves time and money. In one sample trial, conventional methods for measuring and recording measurements needed to build a cabinet took approximately 8 hours. Using wrist writer apparatus 10′ of this invention, the time required to take and record the measurements for the same cabinet was reduced to approximately 2 hours.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A wrist writing apparatus comprising:
an ergonomically shaped chassis for attaching to a wrist including:
two parallel plates each having a pair of lobes on opposite ends of a curved surface, and
a writing surface connected between the two parallel plates;
an attachment device for securing the chassis to the wrist;
rotating shafts each associated with opposite lobes;
a core of a rolled writing substrate disposed about one rotating shaft;
a take-up core disposed about the other rotating shaft; and
the rolled writing substrate is disposed across the writing surface and is attached to the take-up core such that rotating the first and second shafts provides a continuous writing area on the writing substrate disposed across the writing surface.

2. The apparatus of claim 1 further including a securing device for securing a writing device.

3. The apparatus of claim 2 in which the securing device includes a hollow area in one or both of the shafts.

4. The apparatus of claim 2 in which the securing device includes a clip attached to the chassis.

5. The apparatus of claim 1 in which the attachment device includes a flexible band with loop mechanisms on one surface and hook mechanisms on another surface.

6. The apparatus of claim 1 in which the attachment device includes a band with a hook and eye device.

7. The apparatus of claim 6 in which the band is made of a material chosen from the group consisting of: a cloth material, a leather material, a plastic material, and a neoprene material.

8. The apparatus of claim 1 further including a measuring device attached to the attachment device.

9. The apparatus of claim 1 in which one or both of the rotating shafts include a shelf sized to fit at least one orifice.

10. The apparatus of claim 9 in which one or both of the rotating shafts are solid.

11. The apparatus of claim 3 in which the hollow area includes a tapered portion for further securing the writing device.

12. The apparatus of claim 1 in which one of the rotating shafts includes a plurality of splines for securing the core of rolled writing substrate.

13. The apparatus of claim 12 in which the other rotating shaft includes a plurality of splines for securing the take-up core.

14. The apparatus of claim 1 in which the core of a rolled writing substrate includes rolled paper.

15. The apparatus of claim 1 in which one end of one or both of the shafts includes a clip device for securing the shaft to the chassis.

16. The apparatus of claim 1 in which the core of a rolled writing substrate includes preprinted data.

17. The apparatus of claim 5 further including a patch of pressure sensitive hook mechanisms attached to the chassis for engaging the loop mechanisms on the flexible band to attach the attachment device to the chassis.

18. The apparatus of claim 8 further including a patch of pressure sensitive hook mechanisms attached to the measuring device for engaging loop mechanisms on one surface of a flexible band of the attachment device for attaching the measuring device to the flexible band.

19. A wrist measuring and recording apparatus comprising:
an ergonomically shaped chassis for attaching to a wrist including:
two parallel plates each having a pair of lobes on opposite ends of a curved surface, and
a writing surface connected between the two parallel plates;
an attachment device for securing the chassis to the wrist;
a measuring device for performing measurements attached to the attachment device;
rotating shafts each associated with opposite lobes;
a core of a rolled writing substrate disposed about one rotating shaft;
a take-up core disposed about the other rotating shaft; and
the writing substrate is disposed across the writing surface and is attached to the take-up core such that rotating the first and second shafts provides a continuous writing area on the writing substrate disposed across the writing surface for recording one or more measurements on the writing area.

20. A wrist writing apparatus comprising:
an ergonomically shaped chassis for attaching to a wrist including:
two parallel plates each having a pair of lobes, each lobe having an orifice therein, and
a writing surface connected between the two parallel plates;
a first rotating shaft disposed through an orifice in one of the lobes and through an opposing orifice in another lobe;
a second rotating shaft disposed through an orifice in one of the lobes and through an opposing orifice in another lobe;
wherein one of the first and second shafts is hollow for receiving a writing device;
a core of a rolled writing substrate disposed about the first rotating shaft;
a take-up core disposed about the second rotating shaft; and
the writing substrate is disposed across the writing surface and is attached to the take-up core such that rotating the first and second shafts provides a continuous writing area on the writing substrate disposed across the writing surface.

21. A method for measuring and recording measurements to a wrist writing device comprising:
a) performing a measurement using a measuring device attached to the wrist writing device;
b) removing a writing device secured to the wrist writing device; and
c) recording the measurement on a continuous writing area provided by rolled writing substrate disposed across a writing surface of the wrist writing device; and
d) repeating steps a) through c) until a predetermined number of measurements are taken and recorded on the continuous writing area.

22. The method of claim 21 in which the writing device is secured in a hollow area of a rotating shaft associated with the writing device.

23. The method of claim 21 in which the writing device is secured to a chassis of the wrist writing device.
